(19) United States
(12) Patent Application Publication
(10) Pub. No.: US 2017/0040936 A1
(43) Pub. Date: Feb. 9, 2017

(54) Bonding Geometry for T-Bolt to Provide an Electrical and Mechanical Connection

(71) Applicant: Everest Solar Systems, LLC, Oceanside, CA (US)

(72) Inventors: Veit Schutz, Stuttgart (DE); Timothy Vaughn, Edgewood, NM (US)

(21) Appl. No.: 15/177,468

(22) Filed: Jun. 9, 2016

Related U.S. Application Data
(60) Provisional application No. 62/201,110, filed on Aug. 4, 2015.

(51) Int. Cl. H02S 40/30; H01R 4/30; H01R 43/00; H02S 30/10

(52) U.S. Cl. CPC H02S 40/30; H02S 30/10; H01R 4/304; H01R 43/00

(57) ABSTRACT

A device for bonding metallic components, providing a mechanical and electrical connection between interfaced components. The bonding device serves as a structural connection between rails, L-feet, module clamps, climbers, and other component connections within a solar mounting system. The invention uses specialized geometry in its construction to penetrate paints, coatings, and other similar materials to provide an electrical connection. The invention provides an advantage of quick and easy installation of hardware components and associated parts, and meets the demand for a single device capable of forming both a mechanical and electrical connection to associated hardware.

### CLAIM OF PRIORITY

The present application claims priority from Provisional Patent Application No. 62/201,110, filed on Aug. 4, 2015, the disclosure of which is relied upon and incorporated herein by reference.

### FIELD OF INVENTION

This invention relates generally to fastening devices for providing a structural connection. More specifically, the invention relates to a device for providing a mechanical and electrical connection between two parts with flat or substantially flat surfaces of electrically conductive material.

### BACKGROUND OF THE INVENTION

Electrically conductive material, such as aluminum and copper, are used in numerous applications in which it is desired to provide both a physical and electrical connection between different structural components. For example, in structural systems and hardware used for solar panels or other photovoltaic arrangements, it is common to employ rails and fastening components (bonding elements) that require both a mechanical and electrical (such as for grounding purposes) connection.

Solar panels, mounts, and associated structural hardware are commonly installed on roofs or other elevated locations. While working in such locations, installers need to be quick and efficient. Routinely, additional hardware components are used in combination with a bolt, screw, or structural component to provide an electrically interfaced structural connection. These additional hardware components increase the overall cost of mounting systems, while also increasing the time and effort required to install the components.

Because solar panel mounting systems are subjected to adverse environmental conditions, rails or other structural components may be painted, anodized, treated with a protective coating, or coated with another layer of metal to prevent corrosion and/or to provide for a longer life. To form an adequate electrical connection between parts, it is often necessary to penetrate any non-conductive layers, including dirt, paint and corrosion, or skin of the rail or other structural components to provide the necessary electrical connection to the base metal.

Hardware bonding elements suitable for fixing together, both mechanically and electrically, a mounting system rail or other associated components without requiring additional hardware are desirable. It is desirable that bonding element be of simple construction and relatively low cost. These attributes have not been found in a single device.

Thus, a need exists in the industry to address the aforementioned challenges.

### SUMMARY OF THE INVENTION

Solar mounting and structural components require appropriate means of bonding and grounding due to regulations. Embodiments of the present invention provide a bonding device for facilitating quick and easy installation of structural components commonly used in solar mounting systems that may also be utilized in any situation where it is desired to achieve both a mechanical and electrical connection between components.

In an embodiment of the present invention, a bonding device is provided. The bonding device is configured to provide a mechanical and electrical connection to various solar mounting systems. In an aspect, the bonding device includes fixing elements that are configured to create the electrical and mechanical connection to the various components of solar mounting systems. In an exemplary aspect, the fixing elements can comprise protrusions that are configured to penetrate non-conductive layers of the solar mounting systems to create electrical connections with the conductive layers of the components of the solar mounting system. The protrusions can have various structures, including, but not limited to, hemispherical, pyramidal, prismatic, ramp-shaped or any similar structure that serve to penetrate a non-conductive layer on a rail or similar structural connection, such as L-feet, module clamps, climbers, and other component connections within a solar mounting system. In an embodiment, the fixing element is of a material that is stronger than the non-conductive layer and rail material that is also conductive.

In an aspect, the bonding device can include a T-bolt. In an alternate embodiment of the present invention, a T-bolt is provided that can interface with common bonding hardware including clips, washers, lugs, wires, and any other similar hardware to provide both a mechanically and an electrically bonded arrangement.

In an alternate embodiment of the present invention, a nut is provided that can interface with common bonding hardware including various bolts and any other similar hardware to provide both a mechanically and an electrically bonded arrangement.

In another aspect, the bonding device can have a substantially rectangular head. According to an embodiment, this head can have a pair of rounded corners opposite each other. The rounded corners allow the head to be rotated 90 degrees within a slot. Once rotated, the square corners can prevent further rotation.

Other features and advantages of the invention will become apparent to one with skill in the art upon examination of the following drawings and detailed description. It is intended that all such additional features and advantages be included herein within the scope of the present invention.

### BRIEF DESCRIPTION OF THE FIGURES

FIG. 1 provides a pre view of a bonding device according to an aspect of the present invention.

FIG. 1A provides a close up view of components of FIG. 1.

FIG. 2 illustrates a top plan view of the bonding device of FIG. 1.

FIG. 3 illustrates a side plan view of the bonding device of FIG. 1.

FIG. 4 illustrates a side plan view of the bonding device of FIG. 1.

FIG. 5. Illustrates a perspective view of a bonding device according to another aspect of the present invention.

FIG. 5A provides a close up view of components of FIG. 5.

FIG. 6 provides a perspective view of a bonding device according to another aspect of the present invention.

FIG. 6A provides a close up view of components of FIG. 6.

FIG. 7 provides a perspective view of a tightening device that may be used with a bonding device according to an aspect of the present invention.

FIG. 8 is a top view of rail and structural hardware interfaced with a bonding device and nut combination in accordance with an embodiment of the present invention.

FIG. 9 provides a cross-sectional view, taken along lines B-B of FIG. 8, of rail and structural hardware interfaced with a bonding device and nut combination in accordance with an embodiment of the present invention.

FIG. 10 is a perspective view of a rail and structural component interfaced with a bonding device and nut according to an embodiment of the present invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is to be understood that embodiments of the invention may be practiced without these specific details. In other instances, well-known methods, structures and techniques have been shown in detail in order not to obscure an understanding of this description.

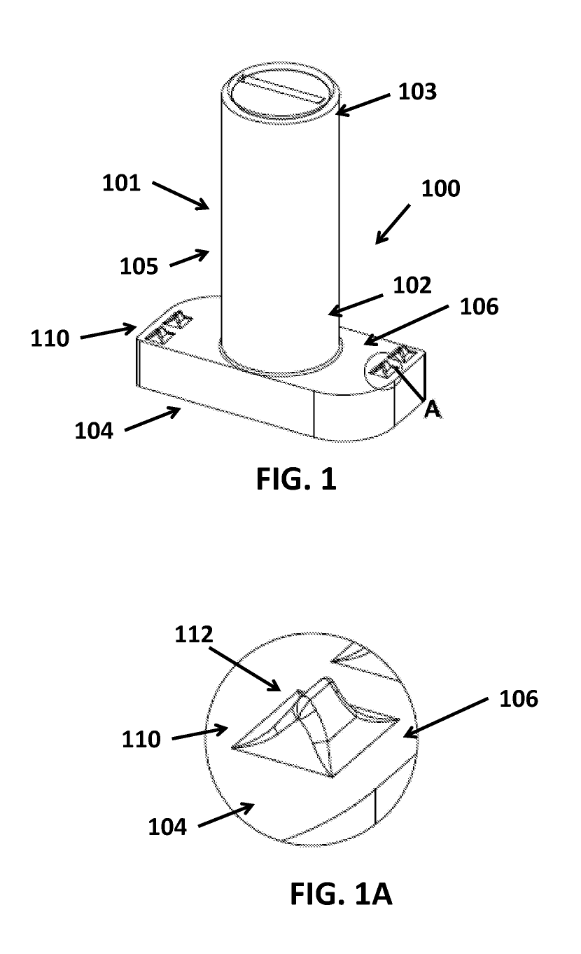

The present invention, as shown in FIGS. 1-4, is directed at a bonding device 100. The bonding device 100 is configured to provide a mechanical and electrical connection to components, including, but not limited to, rails, photovoltaic panels, racking components, wind deflectors, ballast pans, roof anchors, and the like commonly used in solar mounting systems.

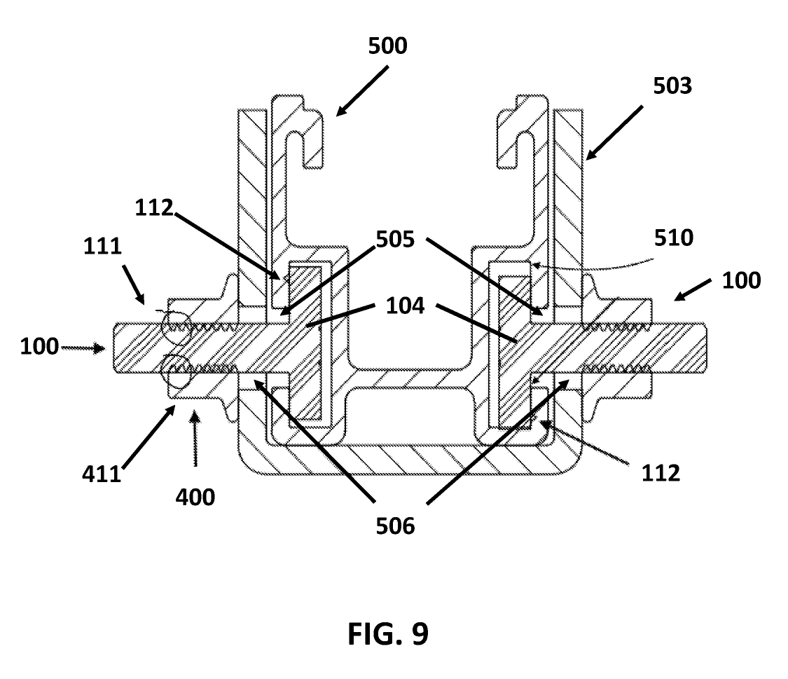

In an aspect, the bonding device 100 comprises a T-bolt 100. However, the bonding device 100 can comprise other various fasteners known in the art, including, but not limited to, hex bolt, allen bolt, and various other bolts and fasteners used to secure components through a slotted extrusion. The T-bolt 100 includes an elongated fastener 101 with a head 104 featured at a proximal end 102 opposite the distal end 103. The head 104 itself is elongated, and interfaces the fastener 101 at a substantially 90 degree angle. As most clearly shown in FIG. 1C, the head 104 has a generally rectangular shape. In an aspect, the generally rectangular shape of the head 104 includes a width that allows the head 104 to be inserted into a mating slots 505, 506 (see FIGS. 9-10) of the rail 500 and structural component 503 respectively, discussed in detail below. In this embodiment, two corners of the head 104 may be rounded at opposite edges, which allow the fastener 101 to be rotated into position after insertion in the slots 505, 506. As shown in the attached embodiments, the other two corners of the head 104 are substantially square-shaped, which ensures that the rotation of the fastener 101, and the head 104, is limited to approximately 90 degrees with the mating slot 505 of the rail 500, thereby ensuring that the fixing elements 110 are in the correct position. However, in other aspects, the head 104 of the bonding device 100 can comprise various shapes. But it is preferred that the head 104 have a shape that facilitates ease of securing the bonding device 100 to the components of the solar mounting system.

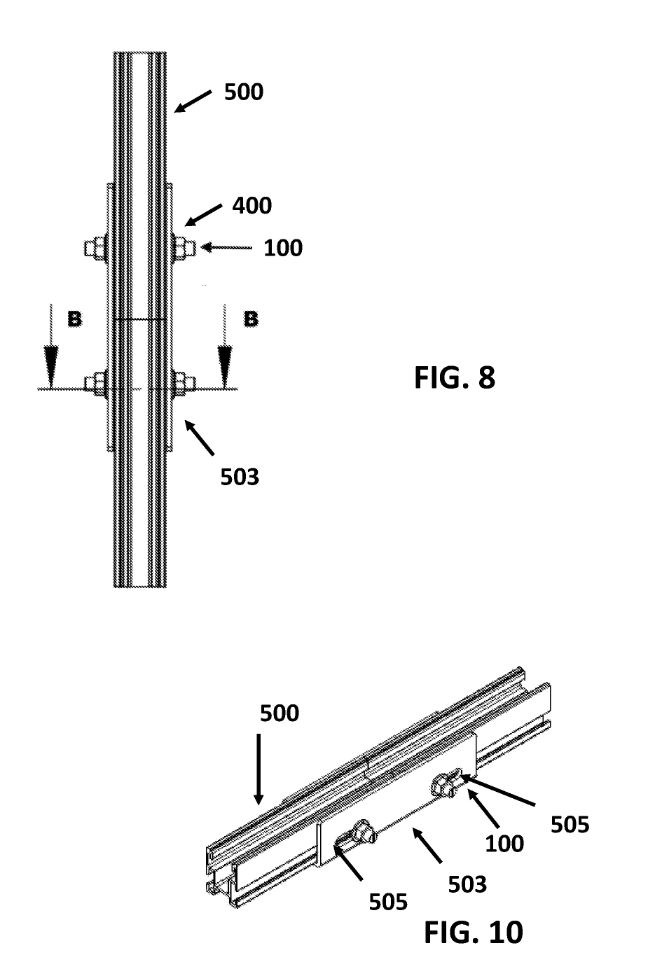

In an aspect, the elongated fastener 101 has a cylindrical body 105 that extends from an inner surface 106 of the head 104. The surface of the fastener 101 may be smooth, or the surface may feature a thread 111 (see FIG. 8). The thread 111 may be a helical structure used to convert between rotational and linear movement (force). In some aspects, the surface of the fastener 101 may be a combination of a partial thread 111 and smooth surface.

Various embodiments of the bonding device 100, 200, 300 are illustrated in FIGS. 1-4 (100), 5 (200), and 6 (300). Each embodiment includes a head 104, 204, 304 extending from or connected to the proximal end 102, 202, 302 of the shank or fastener 101, 201, 301 with the head 104, 204, 304 having an inner or internal surface 106, 206, 306 and an outer or external surface 108, 208, 308. The fastener 101, 201, 301 is connected to the head 104, 204, 304 along the inner surface 106, 206, 306. The bonding device/T-bolt 100, 200, 300 is preferably constructed from a single piece of substantially hard metallic material including carbon steel, stainless steel, titanium, or any other suitable material, such as manufacture by cold forming, turning or forging. However, the head 104, 204, 304 and the fastener 101, 201, 301 may be manufactured individually and then bonded together by welding or any other means which provides suitable strength and rigidity.

The fastener 101, 201, 301 of the bonding device 100, 200, 300 is designed to engage a tightening device 400. In an aspect, the tightening device 400 comprises a nut 400 for tightening purposes. As shown in FIG. 4, the nut 400 is preferably constructed from a single piece of substantially hard metallic material including carbon steel, stainless steel, titanium, or any other suitable material. The nut 400 may feature a preferably hexagon shape on its outer portion 401 and a cylindrical inner portion 402. The surface of the cylindrical inner portion may feature a thread 411 that pairs with a thread 111 around the fastener 101, 201, 301. In aspects in which the fastener 101, 201, 301 is smooth, the tightening device 400 can comprise a push nut fastener (not shown). In other aspects, the tightening device 400 can include, but is not limited to, shaft collars or other retaining element that is designed to secure threaded and non-threaded shafts of the bonding device 100, 200, 300.

The pair of the bonding device 100, 200, 300 and tightening device 400 can be used to convert torque into linear force. Referring to FIGS. 1-6, the rotational movement of the T-bolt 100, 200, 300 or nut 400 along a fixed axis occurs such that the head 104, 204, 304 of the T-bolt 100, 200, 300 moves closer in proximity to the nut 400 (or the nut 400 moves closer to the head 104, 204, 304 of the bonding device 100, 200, 300).

It should be recognized by a person of ordinary skill in the art that an embodiment of the present invention could include different bolt designs including eye, set, hex, or any other similar type without departing from the scope of the invention. A person of ordinary skill in the art will also recognize that an embodiment of the present invention may use different nut designs including flanged, slotted, barrel, t-slot, square, wing, or any similar type without departing from the scope of the invention.

Different embodiments of the bonding device 100, 200, 300 include fixing elements 110, 210, 310. The fixing elements 110, 210, 310 are configured to be able to penetrate a non-conductive coating or skin of the solar mounting elements to facilitate electrical bonding of mating components such as, but not limited to, rails, L-foot, brackets, etc., discussed in more detail below. The fixing elements 110, 210, 310, comprised of a conductive material, can then assist in creating a grounding connection between the bonding device 100, 200, 300 and any solar mounting system components that are part of the bond path. These components include, but are not limited to, photovoltaic panels, racking components, wind deflectors, ballast pans, roof anchors, and the like.

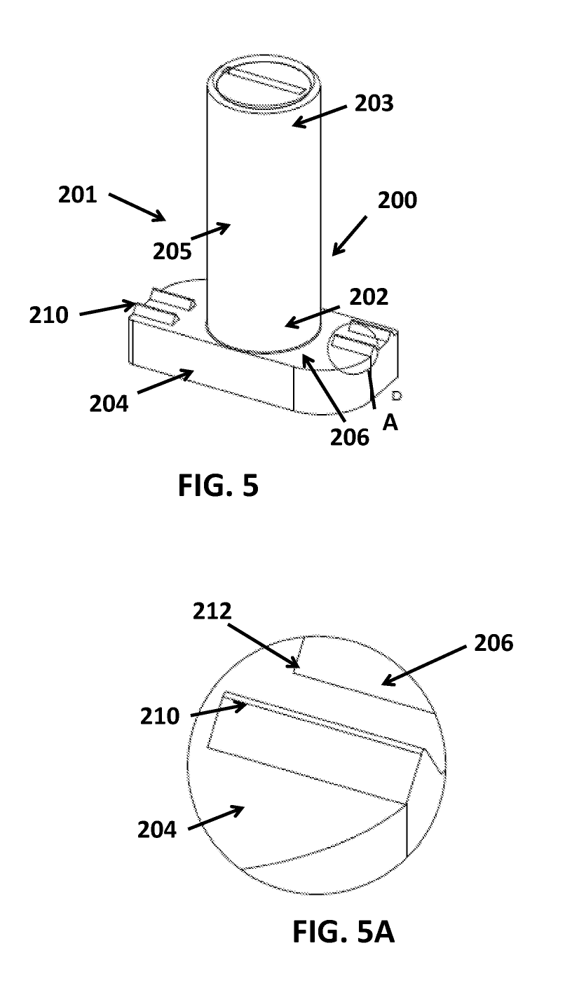

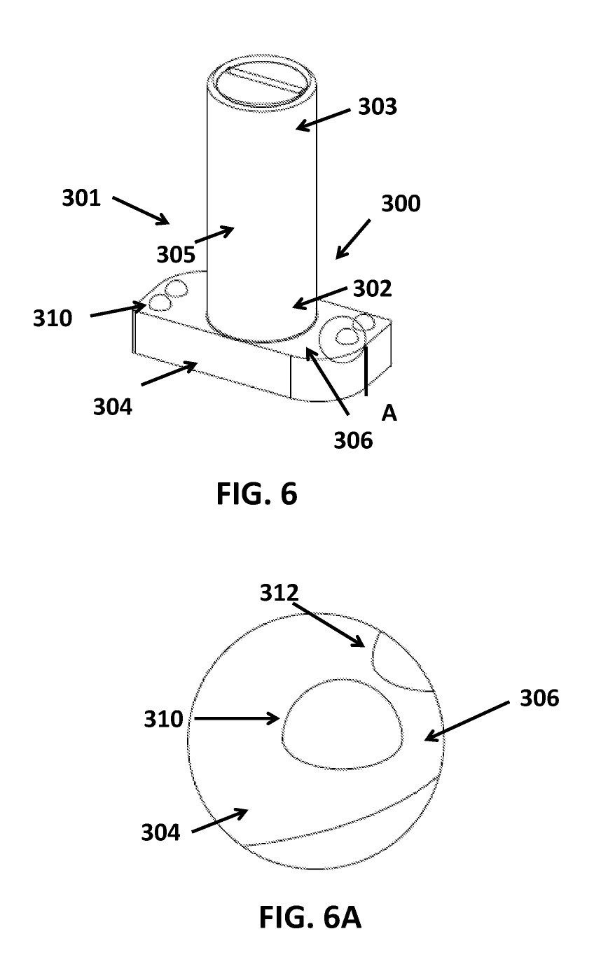

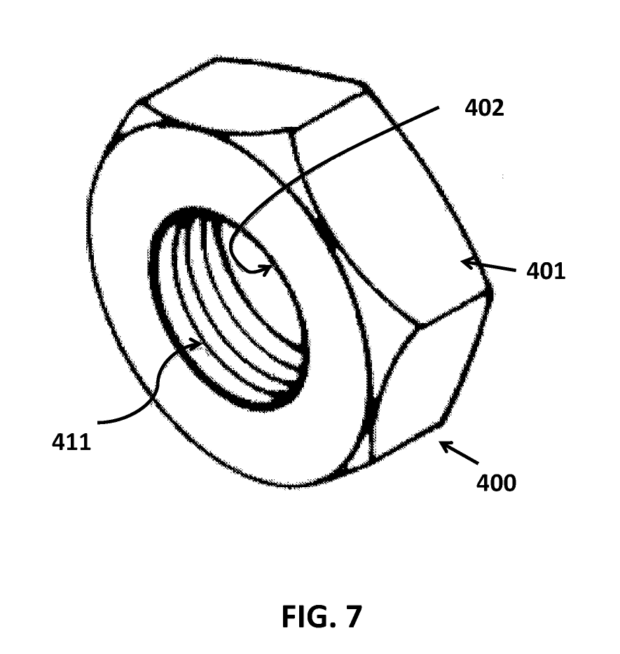

As shown in FIGS. 1-6, the fixing elements 110, 210, 310 can comprise protrusions 112, 212, 312. The protrusions 112, 212, 312 can have different polygon or other geometric shapes, such as hemispherical shape, pin shape, ring shape, prismatic shape, ramp shape, cone shape, and pyramidal shape. The protrusions can be convex shaped and have one or more apices. For example, as shown in FIGS. 1 and 1A, the protrusions 112 are substantially pyramidal shaped or ramp-shaped. FIGS. 5 and 5A illustrate the protrusions 212 as substantially prismatic. FIGS. 6 and 6A illustrate substantially hemispherical protrusions 312. As illustrated, the protrusions 112, 212, 312 can be located on the inner surface 106, 206, 306 of the head 104, 204, 304. Other shapes, such as a circular, trapezoidal, and the like that can pierce the rail 500 and other components 503 could be used in place of the illustrated embodiments.

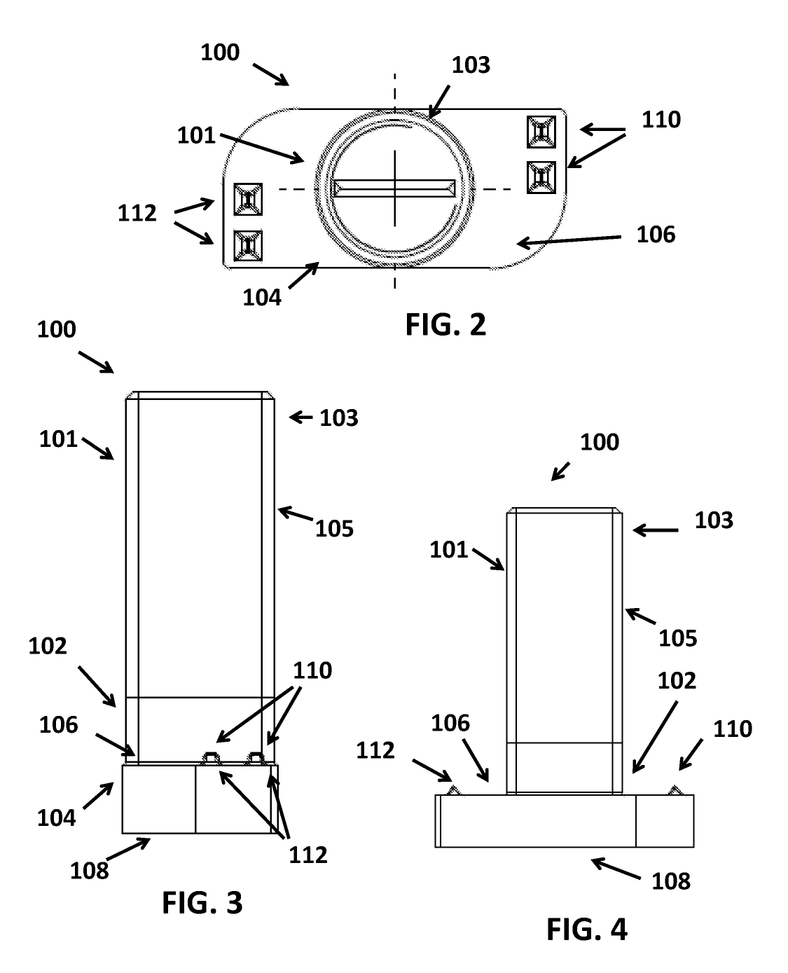

In an aspect, the fixing elements 110, 210, 310 can be positioned equidistant around the inner surface 106, 206, 306 of the head 104, 204, 304 of the bonding device 100, 200, 300. Referring to FIG. 2, the geometric protrusions 112 are positioned proximate the square-shaped corners of the head 104 or centrally located on the head 104 between the corner edge and the curved edge.

In an aspect, the geometric shaped protrusions 112, 212, 312 are made from a substantially hard metallic material that can penetrate a non-conductive layer or skin on a rail 500 or similar structural component 503 (as shown in FIG. 9 and discussed herein). The non-conductive layer 510 may be on a rail 500 or similar structural connection for solar panels, such as L-feet, module clamps, climbers, and other component connections within a solar mounting system. The penetration is achieved by tightening either the associated bonding device (e.g., T-bolt) 100, 200, 300 or tightening device (e.g., nut) 400 to achieve a sufficient force so that the protrusions will engage and extend through the non-conductive layer. After the non-conductive layer 510 is penetrated, the electrically conductive material of the bolt 100 and nut 400 is in contact with the electrically conductive material of the rail 500 or structural component 503. The bolt 100 therefore makes an electrical and mechanical connection with the rail 500 or other structural component.

While the fixing elements 110, 210, 310 discussed above in relation to FIGS. 1-6 disclose protrusions 112, 212, 314 located on the head 104, 204, 304 of the bonding device 100, 200, 300, the fixing elements are not limited to only these forms or locations. For example, the fixing elements can be located along other portions of the bonding device, including the fastener of the bonding device. In such instances, the fixing elements can still comprise protrusions made of a material that is harder than and are still configured to engage the electrically conductive of the material of the rail/structural component, just at a different location, including the interior surface of the slot that receives the bonding device. The fixing elements can take other various forms located at various other locations along the bonding device. However, the fixing elements are configured to create an electrical connection between the bonding device and the other solar system components.

FIGS. 8-10 illustrate the rail 500 and structural hardware 503 interfaced with a bolt 100 and nut 400 combination in accordance with an embodiment of the present invention. FIG. 9 provides a cross-sectional view, taken along lines B-B of FIG. 8, of rail 500 and structural hardware 503 interfaced with a T-bolt 100 and nut 400 combination, illustrating the geometric protrusion 112 after it has penetrated the non-conductive layer 510 of the rail 500.

The t-bolt 100 described herein provides an easier and faster installation, as only one component has to be installed for two functions with use in solar mounting systems. Further, it features fewer parts, thereby resulting in a lower cost for installation.

Having thus described exemplary embodiments of the t-bolt to provide an electrical and mechanical connection, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A bonding device for forming a mechanical and electrical connection with a mating component, the bonding device comprising:
a metallic elongated fastener having a proximal end and a distal end;
a metallic head having an inner surface and an outer surface, the inner surface of the head connected to the proximal end of the fastener; and
at least one protrusion on the inner surface of the head.

2. The device of claim 1, wherein the protrusion on the inner surface of the head is geometric shaped.

3. The bonding device of claim 2, wherein the one or more geometric shaped protrusions is selected from the group of a hemispherical shape, pin shape, ring shape, prismatic shape, ramp shape, cone shape, and pyramidal shape.

4. The device of claim 1, wherein the protrusion is a polygon shape with at least one apex.

5. The device of claim 4, wherein the protrusion is convex.

6. The device of claim 1, wherein the protrusion on the inner surface of the head is made from a substantially hard material.

7. The device of claim 6, wherein the protrusion is configured to penetrate a non-conductive layer of the mating component to reach a conductive layer of the mating component to form the electrical connection.

8. The device of claim 1, wherein the protrusion on the inner surface of the head is made from an electrically conductive material.

9. The device of claim 1, wherein the elongated fastener is threaded.

10. The device of claim 8, further comprising a nut, wherein the nut is threaded so as to be compatible with the threading of the fastener.

11. The device of claim 1, wherein the metallic head is rectangular in shape.

12. The device of claim 11, wherein the metallic head has a first pair of corners opposite each other that are substantially squared and has a second pair of corners opposite each other that are rounded.

13. A mechanical and electrical connection system for solar panel support components, the system comprising:
a bonding device comprising:
a metallic elongated fastener having a proximal end and a distal end;
a metallic head comprising:
an inner surface; and
an outer surface, the inner surface of the head connected to the proximal end of the fastener; and
a mating component comprising an outer surface, wherein the outer surface of the mating component is configured to engage the inner surface of the metallic head of the bonding device; and
at least one protrusion configured to create a mechanical and electrical connection between the bonding device and the mating component, wherein the at least one protrusion is located on the inner surface of the metallic head or the outer surface of the mating component.

14. The system of claim 13, wherein the at least one protrusion is made from a substantially hard and electrically conductive material.

15. The system of claim 14, wherein the at least one protrusion is configured to penetrate a non-conductive layer to make an electrical connection between the bonding device and the mating component.

16. The device of claim 15, wherein the at least one protrusion comprises a plurality of protrusions, and wherein the plurality of protrusions are oriented on the inner surface of the head of the bonding device and the non-conductive layer is oriented on the outer surface of the mating component.

17. A method of creating a mechanical and electrical connection with a mating component having a non-conducting layer and a bonding device, the method comprising:
placing the bonding device through a slot of the first structure, the bonding device comprising:
a metallic elongated fastener comprising:
a proximal end; and
a distal end;
a substantially rectangular metallic head comprising:
an inner surface connected to the proximal end of the fastener;
an outer surface;
a first square corner;
a second square corner opposite the first square corner;
a first rounded corner;
a second rounded corner opposite the first rounded corner;
and at least one protrusion on the inner surface of the head, such that when the elongated fastener is placed through the slot of the first structure, the at least one protrusion is in contact with the non-conducting layer of the first structure;
rotating the bonding device such that the first and second corners are aligned within the slot of the first structure to prevent the bonding device from further rotation; and
attaching a tightening device to the metallic elongated fastener such that the at least one protrusion engages and extends through the non-conducting layer.

18. The method of claim 17, wherein the metallic elongated fastener is threaded.

19. The method of claim 18, wherein the tightening device is a nut.

20. The method of claim 17, wherein the one or more protrusions is selected from the group of a hemispherical shape, pin shape, ring shape, prismatic shape, ramp shape, cone shape, and pyramidal shape.
